(19) United States
(12) Patent Application Publication
(10) Pub. No.: US 2015/0023754 A1
(43) Pub. Date: Jan. 22, 2015

(54) NUT STRUCTURE FOR CONNECTING STRUCTURE

(71) Applicants: FIH (HONG KONG) LIMITED, Kowloon (HK); SHENZHEN FUTAIHONG PRECISION INDUSTRY CO., LTD., Shenzhen (CN)

(72) Inventors: HONG-TAO LIU, Shenzhen (CN); CHIH-WEI CHANG, New Taipei (TW)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 14/068,876

(22) Filed: Oct. 31, 2013

(30) Foreign Application Priority Data
Jul. 19, 2013 (CN) 2013204313167

(51) Int. Cl. F16B 41/00

(52) U.S. Cl. CPC F16B 41/002
USPC 411/103

(57) ABSTRACT

A connecting structure includes a housing and a nut. The housing defines a connecting hole. The nut includes a nut body. A helical section is formed around the nut body and forms a number of tilted ridges. A helical groove is defined between portions of the helical section. The nut body is rotatably received in the connecting hole, and the tilted ridges are embedded in the housing.

### BACKGROUND

1. Technical Field

The present disclosure relates to a nut structure for a connecting structure.

2. Description of Related Art

Many portable electronic devices, such as mobile phones, laptops, and personal digital assistants (PDAs), incorporate at least two housings. The housings need to be fixed together by nuts and bolts. Usually, the nuts are fixed in one of the housings, and the bolts extend through another housing and are further fixed to the nuts for bonding the housings together.

Referring to FIG. 4, a connecting structure 100 includes a first housing 60, a second housing 80, a nut 70, and a bolt 50. The first housing 60 defines a first hole 62, and the second housing 80 defines a second hole 82. To bond the nut 70 to the second housing 80, the nut 70 is heated by a hot pressing block and is directly pressed into the second hole 82 of the second housing 80. When the nut 70 is pressed into the second hole 82, portions of an inner wall of the second hole 82 are melted and are pushed toward a bottom of the second hole 82. The overfilled molten material might easily get into the nut 70. Additionally, a rod portion 52 of the bolt 50 extends through the first hole 62 and is fixed to the nut 70. Since the first housing 60 directly presses the second housing 80, the nut 70 may be separated from the second housing 80. After awhile, the nut 70 easily falls out of the second housing 80.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles. Moreover, in the drawings like reference numerals designate corresponding parts throughout the several views.

FIG. 1 shows a schematic view of an exemplary embodiment of a nut.

FIG. 2 is similar to FIG. 1, but shown from another aspect.

FIG. 3 shows a cross-sectional view of a connecting structure using the exemplary nut.

FIG. 4 shows a cross-sectional view of a connecting structure using a conventional nut.

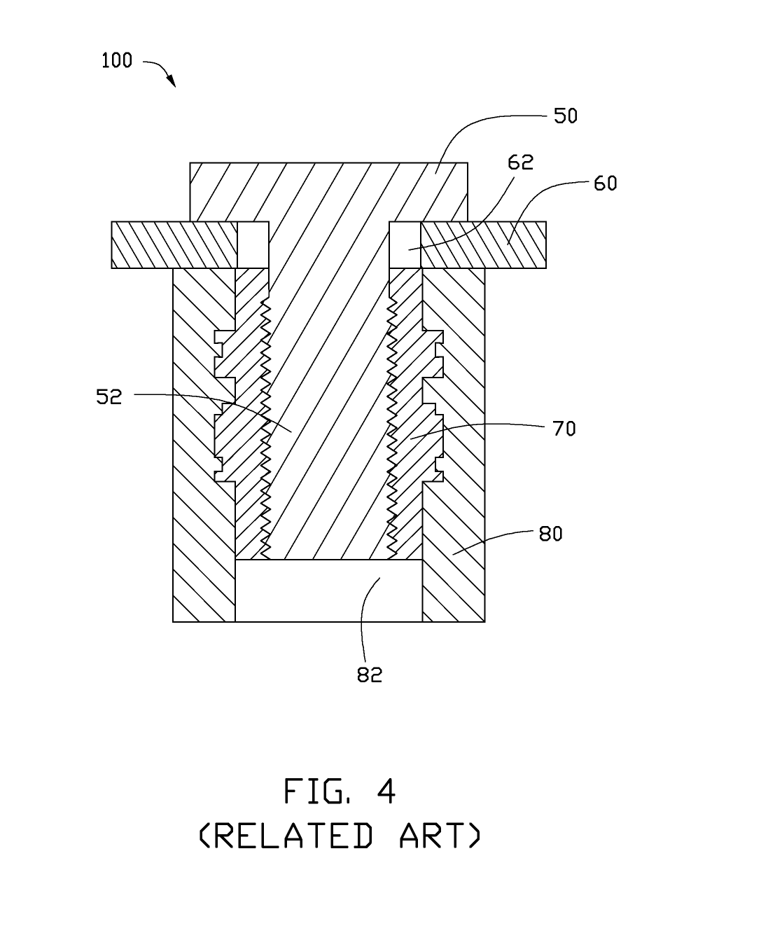

### DETAILED DESCRIPTION

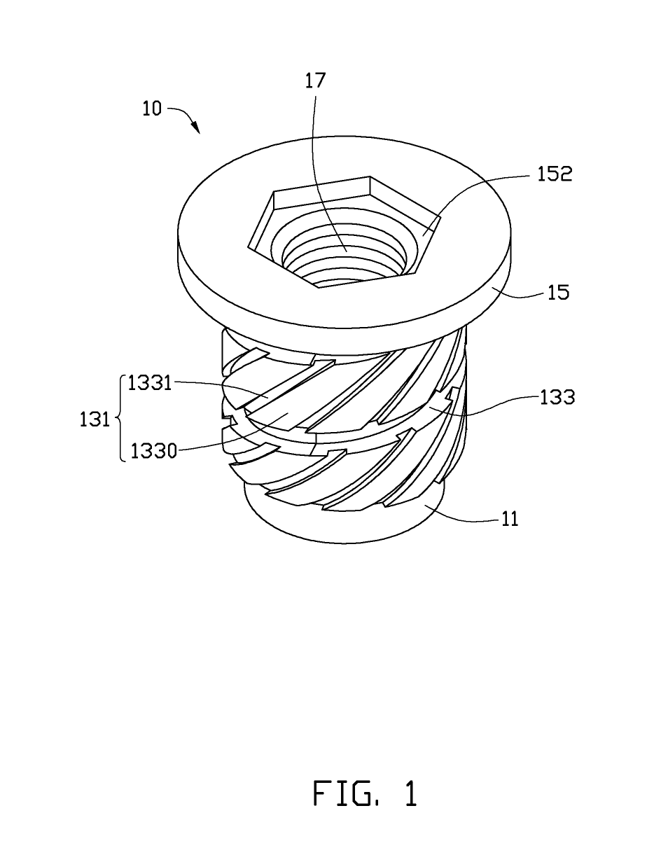

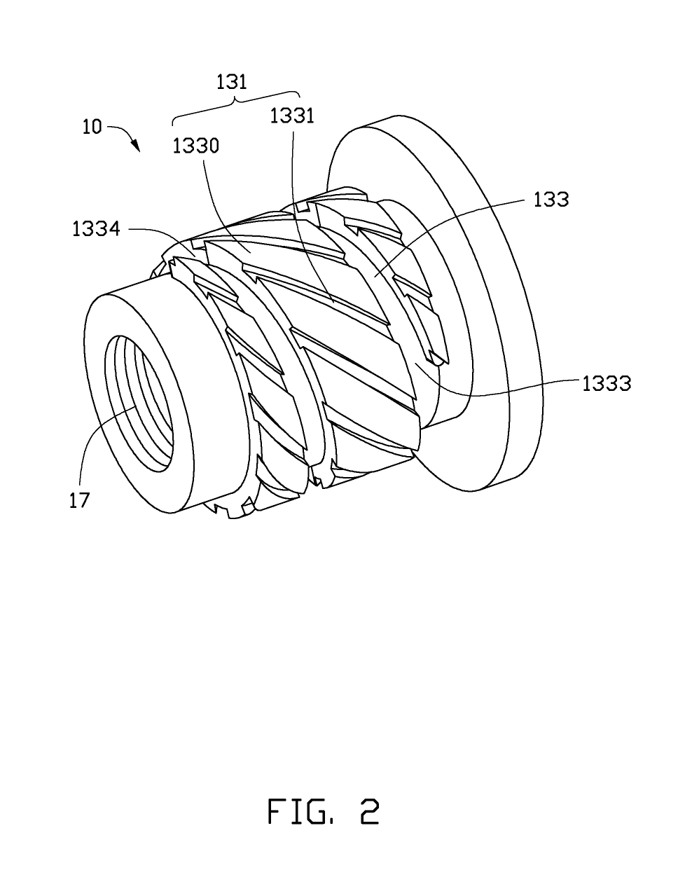

FIGS. 1 and 2 illustrate a nut 10.

The nut 10 is made of metal and includes a nut body 11 and a head portion 15. The nut body 11 is substantially cylindrical and has a helical section 131 wound around the nut body 11. A helical groove 133 is defined between portions of the helical section 131. The helical section 131 forms a plurality of tilted ridges 1330 and defines a plurality of tilted slots 1331. Each tilted slot 1331 is defined between adjacent tilted ridges 1330. The helical groove 133 includes a first end 1333 and a second end 1334. The head portion 15 is substantially a disk-shaped plate and is located at one end of the nut body 11. One surface of the head portion 15 defines a positioning groove 152. In this exemplary embodiment, the positioning groove 152 is hexagonal. A threaded through hole 17 is defined in the positioning groove 152 and the nut body 11.

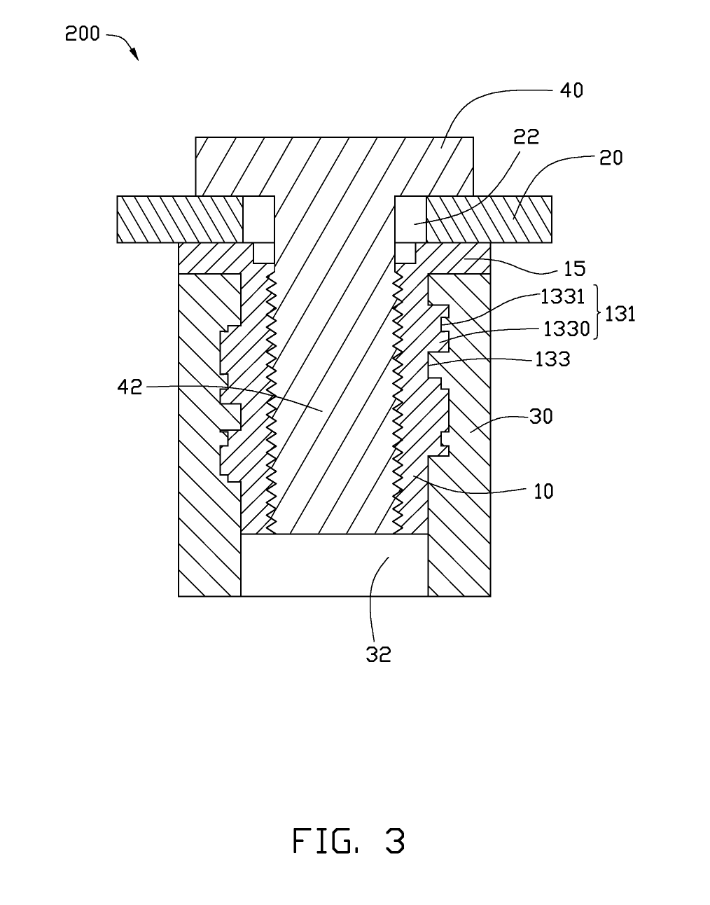

Referring to FIG. 3, the nut 10 is used in a connecting structure 200. The connecting structure 200 includes a first housing 20, a second housing 30, and a bolt 40. The first housing 20 defines a first hole 22, and the second housing 30 defines a second hole 32. To mount the nut 10 in the second housing 30, the nut 10 is firstly loosely received in the second hole 32. Then, a heated pressing block of a heat pressing machine rotates the nut 10. The pressing block driven by the heat pressing machine rotates the nut 10 further into the second hole 32. When the nut 10 rotates, the helical section 131 is rotated into the second hole 32. Simultaneously, the heated nut 10 melts portions of the inner wall of the second hole 32 to form molten material. In the embodiment, the molten material is melted plastic. The molten material flows into the helical groove 133 and the tilted slots 1331. Accordingly, the nut 10 is sealed in the second hole 32 of the housing 30. A rod portion 42 of the bolt 40 is received in the first hole 22 of the first housing 20 and is fixed in the threaded through hole 17 of the nut 10. Thus, the first housing 20 and the second housing 30 are secured to each other.

The connecting structure 200 allows the first housing 20 to be clamped between the bolt 40 and the head portion 15. Since pressure from the first housing 20 is not directly applied onto the second housing 30, the nut 10 will not be pulled away from the second housing 30. Additionally, since the nut 10 is rotated into the second hole 32, the molten material does not accumulate at a bottom of the nut 10, but instead flows into the helical groove 133 and the tilted slots 1331.

The connecting structure 200 greatly improves bonding strength and increases a contact area between the second housing 30 and the nut 10.

It should be also understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A connecting structure comprising:
a housing defining a connecting hole; and
a nut including a nut body, and a helical groove and a helical section formed on the nut body;
wherein the nut body is rotatably received in the connecting hole, and the helical groove and the helical section are embedded into the housing.

2. The connecting structure as claimed in claim 1, wherein the helical section defines a plurality of spaced tilted slots and tilted ridges.

3. The connecting structure as claimed in claim 2, wherein the nut further comprises a head portion positioned at one end of the nut body, the head portion defines a positioning groove configured for being driven by a heat pressing machine.

4. The connecting structure as claimed in claim 3, wherein the positioning groove is hexagonal.

5. An electronic device comprising:
a first housing defining a first hole;
a second housing defining a second hole;
a nut includes a nut body and a head portion, the nut body embedded in the second hole, and the head portion positioned on the second housing; and
a bolt extending through the first hole of the first housing, and fixed to the nut.

6. The electronic device as claimed in claim 5, wherein the nut body defines a helical groove and a helical section, the nut body is rotatably received in the second hole, and the helical groove and the helical section are embedded into the housing.

7. The electronic device as claimed in claim 6, wherein the helical ridge defines a plurality of spaced tilted slots and tilted ridges.

8. The electronic device as claimed in claim 5, wherein the nut further comprises a head portion positioned at one end of the nut body, the head portion defines a positioning groove configured for being driven by a heat pressing machine.

9. The electronic device as claimed in claim 8, wherein the positioning groove is hexagonal.
